(19) United States
(12) Patent Application Publication
(10) Pub. No.: US 2024/0079638 A1
(43) Pub. Date: Mar. 7, 2024

(54) FABRICATION OF SULFIDE-BASED SOLID-STATE BATTERY WITH HIGH-SPEED ZIG-ZAG STACKING

(71) Applicant: GM GLOBAL TECHNOLOGY OPERATIONS LLC., Detroit, MI (US)

(72) Inventors: Qili SU, Shanghai (CN); Zhe Li, Anda (CN); Yong Lu, Shanghai (CN); Haijing Liu, Shanghai (CN)

(21) Appl. No.: 17/961,762

(22) Filed: Oct. 7, 2022

(30) Foreign Application Priority Data
Sep. 6, 2022 (CN) 2022110833618

(51) Int. Cl. H01M 10/0562; H01M 4/36; H01M 4/505; H01M 4/525; H01M 10/0525

(52) U.S. Cl. CPC H01M 10/0562; H01M 4/364; H01M 4/505; H01M 4/525; H01M 10/0525; H01M 2220/20; H01M 2300/0065

(57) ABSTRACT

A battery cell includes a continuous anode electrode comprising an anode current collector. A plurality of individual cathode electrodes include a cathode current collector, cathode active material arranged on opposite sides of the cathode current collector, and a first sulfide electrolyte layer arranged on the cathode active material. The continuous anode electrode is arranged in a zig-zag pattern and the plurality of individual cathode electrodes are arranged between adjacent alternating portions of the continuous anode electrode.

### CROSS-REFERENCE TO RELATED APPLICATIONS

This application claims the benefit of Chinese Patent Application No. 202211083361.8, filed on Sep. 6, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells for electric vehicles or other applications.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased power density to increase the range of the EVs.

Lithium-ion battery (LIB) cells are currently used for high power density applications. All-solid-state battery (ASSB) cells have improved characteristics compared to LIB cells in terms of abuse tolerance, power capability and/or working temperature range.

### SUMMARY

A battery cell includes a continuous anode electrode comprising an anode current collector. A plurality of individual cathode electrodes comprise a cathode current collector, cathode active material arranged on opposite sides of the cathode current collector, and a first sulfide electrolyte layer arranged on the cathode active material. The continuous anode electrode is arranged in a zig-zag pattern and the plurality of individual cathode electrodes are arranged between adjacent alternating portions of the continuous anode electrode.

In other features, a highest point of the anode current collector minus a lowest point of the anode current collector is in a range from 1 μm to 20 μm. The continuous anode electrode further includes anode active material arranged on opposite sides of the anode current collector. The continuous anode electrode further comprises a second sulfide electrolyte layer arranged on the anode active material. The first sulfide electrolyte layer and the second sulfide electrolyte layer are selected from a group consisting of pseudobinary sulfide, pseudoternary sulfide, and pseudoquaternary sulfide.

In other features, the anode active material includes a material selected from a group consisting of silicon, columnar silicon, silicon-containing alloys, and silicon-graphite mixture. The anode active material comprises a material selected from a group consisting of tin, aluminum, indium, and magnesium.

In other features, the cathode active material comprises one or more positive electroactive materials selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. The cathode active material is at least one of coated and doped. The first sulfide electrolyte layer is selected from a group consisting of pseudobinary sulfide, pseudoternary sulfide, and pseudoquaternary sulfide.

A battery cell comprises a plurality of individual anode electrodes comprising an anode current collector. A continuous cathode electrode comprises a cathode current collector, cathode active material arranged on opposite sides of the cathode current collector at spaced intervals, and a first sulfide electrolyte layer arranged on the cathode active material and on the cathode current collector in between the cathode active material. The continuous cathode electrode is arranged in a zig-zag pattern and the plurality of individual anode electrodes are located between adjacent alternating portions of the continuous cathode electrode.

In other features, the plurality of individual anode electrodes further includes anode active material arranged on opposite sides of the anode current collector. The anode active material includes a material selected from a group consisting of a carbonaceous material, silicon, a transition metal, a metal oxide, a lithium metal, a lithium alloy metal, and combinations thereof.

In other features, the lithium alloy metal further comprises a material selected from a group consisting of tin, aluminum, indium, and magnesium. The cathode active material comprises one or more positive electroactive materials selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof.

In other features, the positive electroactive materials are coated. The positive electroactive materials are coated with one or more materials selected from a group consisting of LiNbO₃ and Al₂O₃. The positive electroactive materials are doped. The positive electroactive materials are doped with one or more materials selected from a group consisting of aluminum and magnesium.

In other features, the first sulfide electrolyte layer is selected from a group consisting of pseudobinary sulfide, pseudoternary sulfide, and pseudoquaternary sulfide.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of an anode electrode according to the present disclosure;

FIG. 2 is a side cross-sectional view of an example of a cathode electrode according to the present disclosure;

FIG. 3 is a simplified side cross-sectional view of an example of a battery cell including a continuous anode electrode having a zig-zag shape and individual cathode electrode during assembly according to the present disclosure;

FIG. 4 is a more detailed side cross-sectional view of an example of a battery cell a continuous anode electrode having a zig-zag shape and individual cathode electrodes after assembly according to the present disclosure;

FIG. 5 is an enlarged side cross-sectional view of an example of a cathode electrode according to the present disclosure;

FIGS. 6A and 6B illustrate an example of a method for manufacturing the cathode electrodes according to the present disclosure;

FIGS. 7A to 7C are side cross-sectional views of examples of the anode electrode according to the present disclosure;

FIG. 8 is a side cross-sectional views of an example of a cathode electrode according to the present disclosure;

FIG. 9 is a simplified side cross-sectional view of an example of a battery cell including a continuous cathode electrode having a zig-zag shape and individual anode electrodes during assembly according to the present disclosure;

FIG. 10 is a more detailed side cross-sectional view of an example of a battery cell a continuous cathode electrode having a zig-zag shape and individual anode electrodes after assembly according to the present disclosure;

FIGS. 11A and 11B illustrate an example of a method for manufacturing the continuous cathode electrodes of FIG. 10 according to the present disclosure;

FIG. 12 is a side cross-sectional view of an example of the continuous cathode electrodes according to the present disclosure;

FIG. 13 is a side cross-sectional view of an example of the anode electrode according to the present disclosure;

FIGS. 14 to 16B illustrate an example of placement of external tabs for a battery cell including a continuous anode electrode and individual cathode electrodes according to the present disclosure; and

FIGS. 17 to 19B illustrate an example of placement of external tabs for a battery cells including a continuous cathode electrode and individual anode electrodes according to the present disclosure.

In the drawings, reference numbers may be reused to identify similar and/or identical elements.

### DETAILED DESCRIPTION

While the battery cells according to the present disclosure are described below in the context of a vehicle, the battery cells according to the present disclosure can be used in other applications.

All-solid-state battery (ASSB) cells using sulfide electrolyte have improved characteristics compared to current lithium-ion battery (LIB) cells in terms of abuse tolerance, power capability and/or working temperature range. However, the mechanical bendability of electrodes and/or separating layers is currently limited. In some ASSB prototype battery cells, uniform sheet-type electrodes are manufactured using a wet-coating process. A cathode coating is applied to opposite sides of a cathode current collector. After drying and calendaring, individual cathodes are punched into a sheet format. An anode coating is applied to opposite sides of an anode current collector. After drying and calendaring, an electrolyte coating is applied to the anode coatings. After drying and calendaring the electrolyte coating, the anode/electrolyte sheets are punched into a sheet format. The sheets including the cathodes and anodes are stacked one by one, which requires high accuracy of electrode positioning. This type of fabrication of ASSB cells is not very efficient, which increases the cost of the battery cells. Improper positioning may lead to reduced reliability.

The present disclosure relates to a continuous fabrication process for scalable all-solid-state battery (ASSB) using high-speed zig-zag stacking of continuous bendable anode electrodes (with individual cathode electodes) or continuous bendable cathode electrodes (with individual anode electrodes). In some examples, sulfide-based electrolyte is used.

In some examples, the cathode electrode is covered by a thin and uniform sulfide electrolyte layer using a slurry coating process. The cathode-supported sulfide dual layers are stacked between a continuous anode electrode using a battery zig-zag fabrication line. The fabrication methods described herein enable continuous sulfide-based ASSB fabrication with high production efficiency and improved reliability.

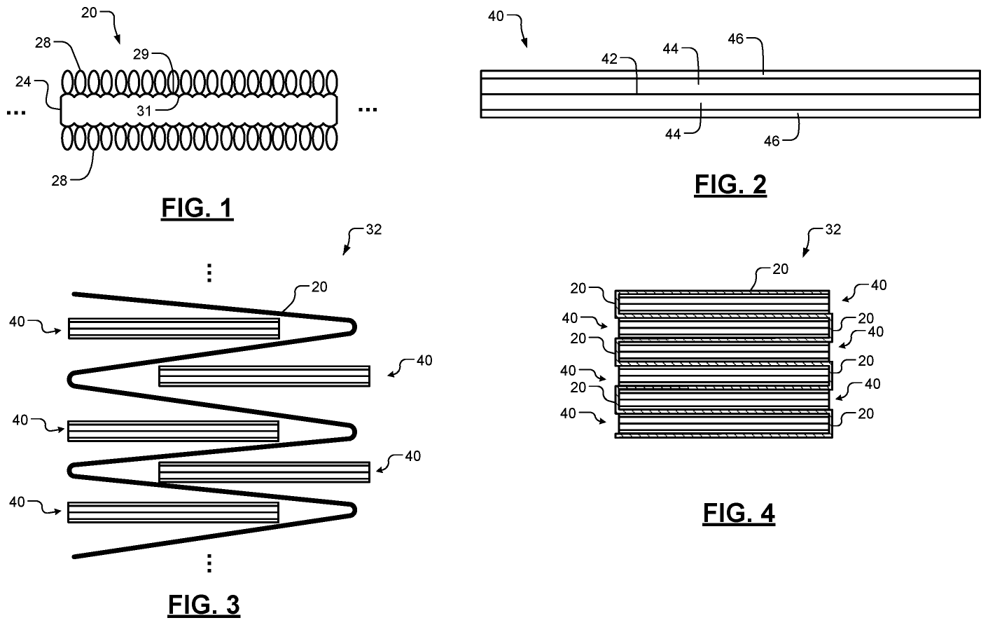

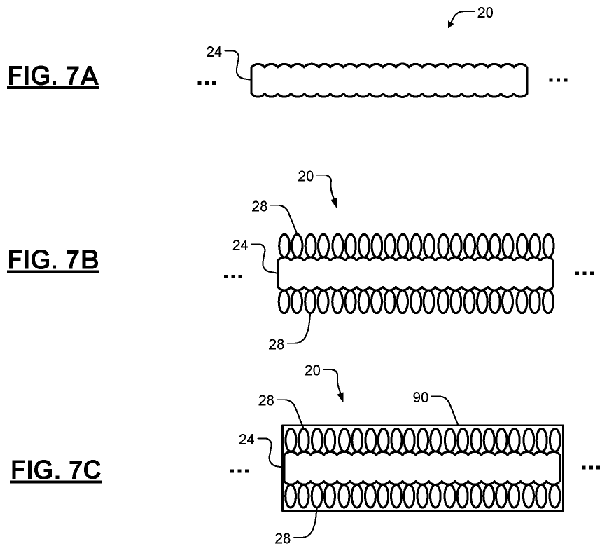

Referring now to FIG. 1, an example of an anode electrode 20 is shown to include an anode current collector 24 and anode active material 28 arranged in a layer located on opposite sides thereof. In some examples, the anode current collector 24 comprises copper foil. In some examples, the anode active material 28 comprises silicon (Si). In some examples, the anode active material 28 comprises columnar silicon (Si). In some examples a surface of the anode current collector 24 is roughened prior to coating. In some examples, a highest point 29 of the current collector minus a lowest point 31 of the current collector) is in a range from 1 μm to 20 μm. In other examples, the continuous anode electrodes 20 can have any of the arrangements shown in FIGS. 7A to 7C described below.

Referring now to FIG. 2, a cathode electrode 40 is shown to include a cathode current collector 42, cathode active material 44 arranged on opposite sides of the cathode current collector 42 and an electrolyte layer 46 arranged on the cathode active material 44. In some examples, the electrolyte layer 46 comprises sulfide electrolyte.

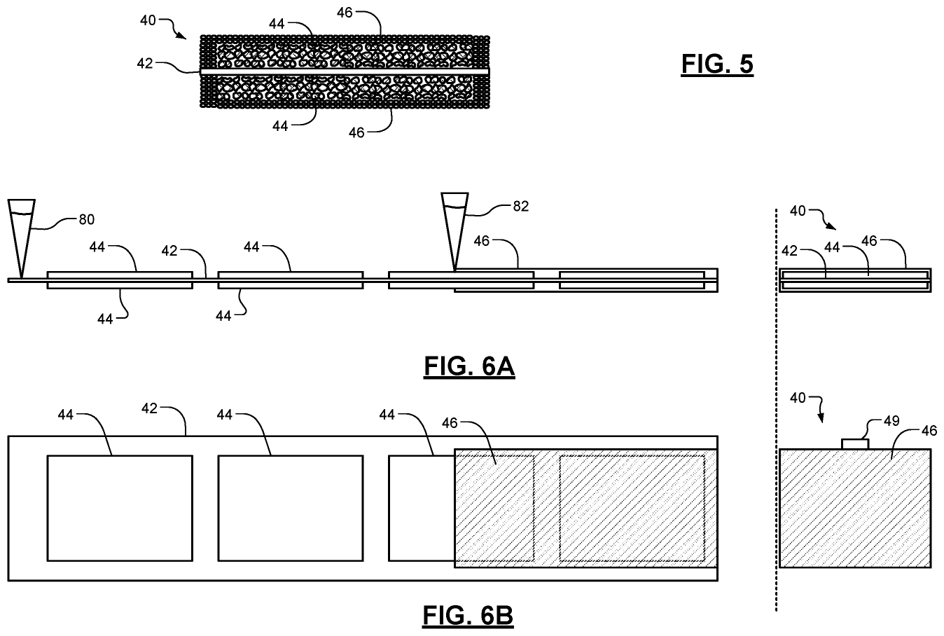

Referring now to FIGS. 3 and 4, a battery cell 32 includes the continuous anode electrode 20. In some examples, the continuous anode electrode 20 has a zig-zag shape that extends back and forth in a repeating “Z” pattern. The cathode electrodes 40 are arranged between adjacent portions of the continuous anode electrode 20. Continuous high-speed zig-zag stacking is realized by a continuous and bendable anode electrode with low loading and multiple cathode-supported dual layers arranged between adjacent alternating portions of the anode electrode. The term continuous anode electrode refers to an anode electrode that is continuous between opposite ends thereof and has a length that is greater than the number of individual cathode electrodes of the battery cell times the width of the individual cathode electrodes.

Referring now to FIG. 5, the cathode electrode 40 is shown to include the cathode current collector 42, the cathode active material 44 arranged on opposite sides of the cathode current collector 42 and the electrolyte layer 46 arranged on the cathode active material 44. In some examples, the cathode active material 44 comprises lithium such as NMC532, although other cathode active materials can be used. In some examples, the electrolyte material comprises a sulfide electrolyte coating. In some examples, the sulfide electrolyte coating comprises Li₆PS₅Br.

Referring now to FIGS. 6A to 6C, a method for manufacturing the cathode electrodes in FIGS. 2-5 is shown. In FIGS. 6A and 6B, the cathode current collector 42 comprises a continuous foil layer. In some examples, the cathode current collector 42 comprises aluminum foil. Cathode active material 44 from a source 80 of slurry is applied to opposite sides of the current collector at spaced intervals corresponding to a width of the electrodes. The cathode active material 44 is dried and calendared. Calendering includes compressing the dried electrode to reduce porosity, improve particle contact and enhance energy or power density. Then the electrolyte layer 46 is applied to the opposite sides of the cathode active material 44 and spaces on the cathode current collector 42 located there between. The electrolyte layer 46 is dried and calendared, and then individual ones of the cathode electrodes are punched or separated. An external tab 49 extending from a side thereof is defined during the punching procedure.

Referring now to FIGS. 7A to 7C, examples of the continuous anode electrode 20 are shown. In FIG. 7A, the continuous anode electrode 20 includes the anode current collector 24 for anode-free applications. In FIG. 7B, the continuous anode electrode 20 includes the anode current collector 24 and the anode active material 28. In FIG. 7C, the continuous anode electrode 20 includes the anode current collector 24, the anode active material 28, and the electrolyte coating 90.

In some examples, the continuous anode electrode 20 comprises a thin lamination layer with flexibility to enable bending. In some examples, the anode current collector 24 comprises copper foil. In some examples, the anode active material 28 comprises silicon. In some examples, the anode active material 28 comprises columnar silicon, silicon-containing alloys, or silicon-graphite mixture. In some examples, the anode active material 28 comprises materials with specific capacity greater than 800 mAh/g, such as tin, aluminum, indium, and magnesium. In some examples, the anode active material 28 comprises columnar silicon. In some examples, the anode active material has a thickness t1 in a range from 0 μm<t<=20 μm. In some examples, the anode active material has a thickness t in a range from 3 μm<t1<=8 μm. In some examples, outer surfaces of the anode current collector 24 are roughened to strengthen the adhesion between current collector and anode active material. In some examples, the anode current collector 24 has a thickness t2 in a range from 4 μm to 30 μm. In some examples, the anode current collector 24 has a thickness in a range from 12 μm to 16 μm (e.g., 14 μm).

In some examples, the electrolyte coating 90 (e.g., sulfide electrolyte) is applied to the anode active material to avoid potential fabrication short circuits and to enhance performance. In some examples, the sulfide electrolyte has a thickness t3 in a range from 0 μm<t3<=5 μm. In some examples, the sulfide electrolyte has a thickness t3 in a range from 0.5 μm<t3<=1.5 μm (e.g., 1 μm). In some examples, the continuous anode electrode 20 is impregnated with precursor solution of sulfide electrolyte followed by the solidification of sulfide electrolyte.

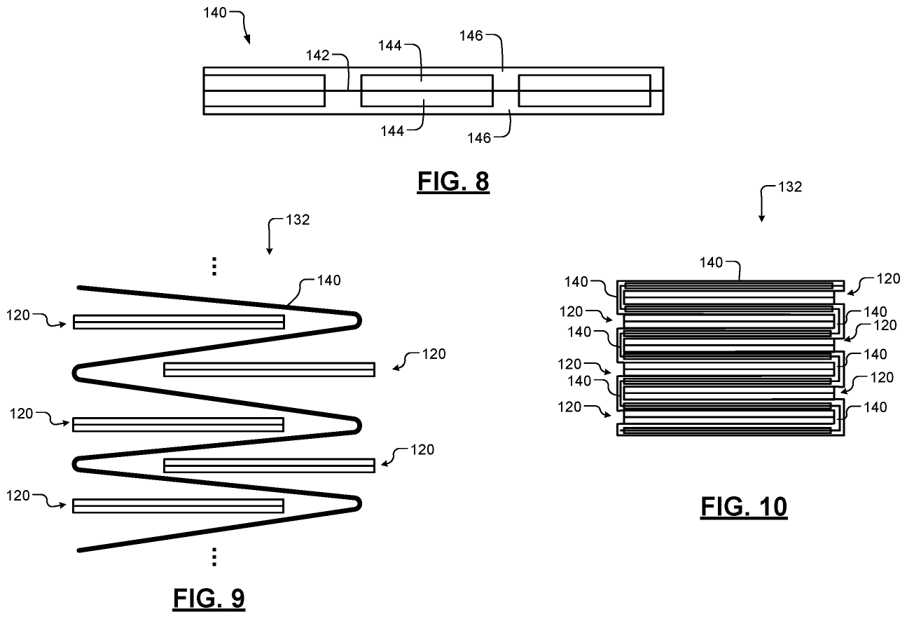

Referring now to FIGS. 8 to 10, the cathode electrode can be continuous, and the anode electrodes can include individual anode electrodes inserted into between adjacent alternating portions of the continuous cathode electrode. In FIG. 8, a cathode electrode 140 is continuous and is shown to include a cathode current collector 142, cathode active material 144 arranged on opposite sides of the cathode current collector 142 in spaced locations, and an electrolyte layer 146 arranged on opposite sides of the cathode active material 144 and between the cathode active material 144. The term continuous cathode electrode refers to a cathode electrode that is continuous between opposite ends thereof and has a length that is greater than the number of individual anode electrodes 120 of the battery cell times the width of the individual anode electrodes 120. As can be seen, the bends of the continuous cathode electrodes are made in locations between the cathode active material.

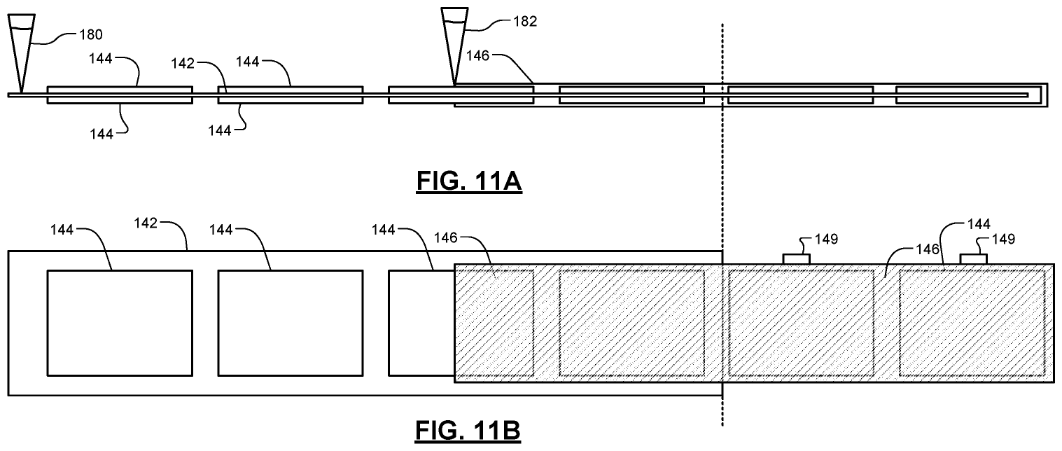

In FIGS. 9 and 10, a battery cell 132 includes the cathode electrode 140 that is continuous and has a repeating “Z” shape or zig-zag shape. Individual anode electrodes 120 are arranged between adjacent portions of the cathode electrode 140. The individual anode electrodes 120 can have any of the arrangements shown in FIGS. 7A to 7C.

Referring now to FIGS. 11A and 11B, a method for manufacturing the cathode electrodes in FIGS. 8-9 is shown. In FIGS. 11A and 11B, the cathode current collector 142 comprises a continuous foil layer. Cathode active material 144 from a source 180 of slurry is applied to opposite sides of the cathode current collector 142 at spaced intervals. The cathode active material 144 is dried and calendared and then the electrolyte layer 146 is applied to the opposite sides of the cathode active material 144 and spaces on the cathode current collector 142 located there between. The electrolyte layer 146 is dried and calendared, and an external tab 149 is defined during the punching procedure.

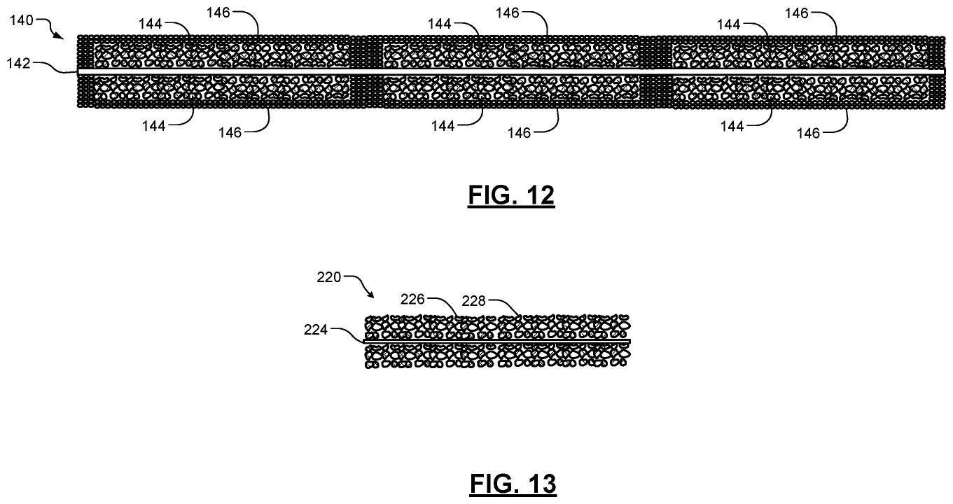

Referring now to FIG. 12, the cathode electrode 140 is shown to include the cathode current collector 142, the cathode active material 144 arranged on opposite sides of the cathode current collector 142 in spaced locations, and the electrolyte layer 146 arranged on opposite sides of the cathode active material 144 and between the cathode active material 144. In some examples, the cathode active material 44 comprises NMC532. In some examples, the electrolyte material comprises a sulfide electrolyte coating. In some examples, the sulfide electrolyte coating comprises Li₆PS₅Br. In some examples, the cathode current collector 142 comprises aluminum foil.

Referring now to FIG. 13, an anode electrode 220 is shown. The anode electrode 220 includes anode active material 226 and an electrolyte material 228 (intermixed with the anode active material 226) arranged on a current collector 224. The anode active material 226 can be any traditional anode active material. In some examples, the anode active material 226 is selected from a group consisting of carbonaceous material (e.g., graphite, hard carbon, soft carbon etc.), silicon, silicon mixed with graphite, Li₄Ti₅O₁₂, transition-metal (e.g., Sn), metal oxide/sulfide (e.g., titanium oxide (TiO₂), iron sulfide (FeS), etc.), and other lithium-accepting anode active materials. In some examples, the electrolyte material 228 comprises sulfide electrolyte. In some examples, the sulfide electrolyte comprises Li₆PS₅Br. In some examples, a conductive additive is used to increase favorable electron conduction.

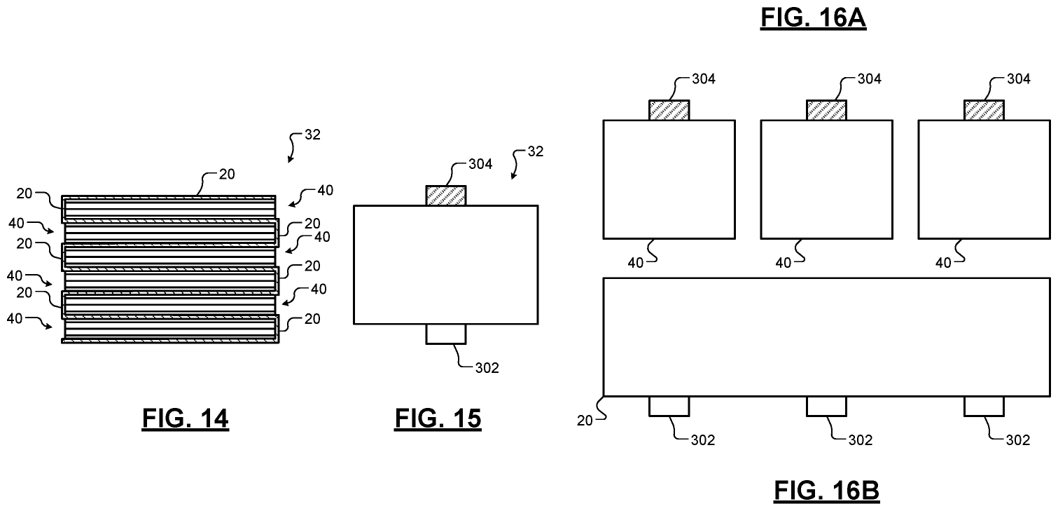

Referring now to FIGS. 14 to 16B, examples of tab placement are shown for the battery cell with the continuous anode electrode and individual cathode electrodes. The continuous anode electrode 20 includes spaced external tabs 302 The individual cathode electrodes 40 includes spaced external tabs 304. While the external tabs are located on opposite sides, the external tabs 302 and 304 can be arranged on the same side and offset from each other.

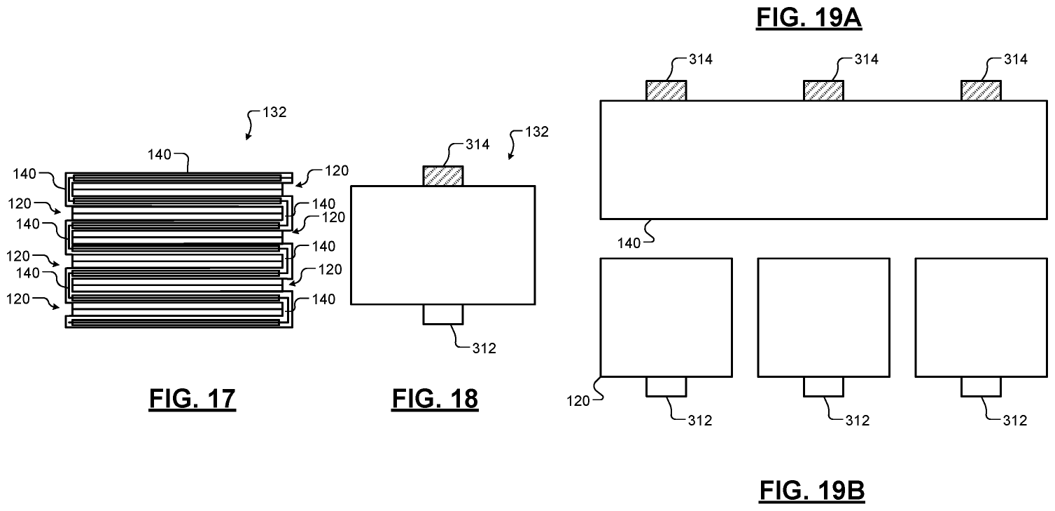

Referring now to FIGS. 17 to 19B, examples of tab placement are shown for the battery cell with the continuous cathode electrode and individual anode electrodes. The individual anode electrodes 120 include spaced external tabs 312 The continuous cathode electrodes 140 include spaced external tabs 314. While the external tabs are located on opposite sides, the external tabs 312 and 314 can be arranged on the same side and offset from each other.

While the preceding examples specified Li₆PS₅Br as an example of the sulfide electrolyte, other types of sulfide electrolyte can be used. In some examples, the sulfide electrolyte is selected from a group consisting of pseudobinary sulfide, pseudoternary sulfide, and pseudoquaternary sulfide.

Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, and Li₂S—Al₂S₃ system.

Examples of pseudoternary sulfide include Li₂O—Li₂S—P₂S₅ system, Li₂S—P₂S₅—P₂O₅ system, Li₂S—P₂S₅—GeS₂ system, (Li_{3.25}Ge_{0.25}P_{0.75}S₄ and Li₁₀GeP₂S₁₂), Li₂S—P₂S₅—LiX system (where X═F, Cl, Br, I), (Li₆PS₅Br, Li₆PS₅Cl, L₇P₂S₈I and Li₄PS₄I), Li₂S—As₂S₅—SnS₂ system, (Li_{3.633}Sn_{0.633}As_{0.166}S₄) system, Li₂S—P₂S₅—Al₂S₃ system, Li₂S—LiX—SiS₂ system (where X═F, Cl, Br, I), 0.4LiI-0.6Li₄SnS₄ and Li₁₁S₁₂PS₁₂.

Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1} S_{10.7}I_{0.3} and Li_{10.35}[Sn_{0.27}Si_{1.08}]P_{1.65}S₁₂.

As can be appreciated, the fabrication process can be extended to other types of battery cells (e.g., other types of solid-state batteries and/or liquid-based batteries) with thin anode and cathode supported dual layers.

In some examples, the cathode active material comprises one or more positive electroactive materials selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
a continuous anode electrode comprising an anode current collector; and
a plurality of individual cathode electrodes comprising a cathode current collector, cathode active material arranged on opposite sides of the cathode current collector, and a first sulfide electrolyte layer arranged on the cathode active material,
wherein the continuous anode electrode is arranged in a zig-zag pattern and the plurality of individual cathode electrodes are arranged between adjacent alternating portions of the continuous anode electrode.

2. The battery cell of claim 1, wherein a highest point of the anode current collector minus a lowest point of the anode current collector is in a range from 1 μm to 20 μm.

3. The battery cell of claim 1, wherein the continuous anode electrode further includes anode active material arranged on opposite sides of the anode current collector.

4. The battery cell of claim 3, wherein the continuous anode electrode further comprises a second sulfide electrolyte layer arranged on the anode active material.

5. The battery cell of claim 4, wherein the first sulfide electrolyte layer and the second sulfide electrolyte layer are selected from a group consisting of pseudobinary sulfide, pseudoternary sulfide, and pseudoquaternary sulfide.

6. The battery cell of claim 3, wherein the anode active material includes a material selected from a group consisting of silicon, columnar silicon, silicon-containing alloys, and silicon-graphite mixture.

7. The battery cell of claim 3, wherein the anode active material comprises a material selected from a group consisting of tin, aluminum, indium, and magnesium.

8. The battery cell of claim 1, wherein the cathode active material comprises one or more positive electroactive materials selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof.

9. The battery cell of claim 8, wherein the cathode active material is at least one of coated and doped.

10. The battery cell of claim 1, wherein the first sulfide electrolyte layer is selected from a group consisting of pseudobinary sulfide, pseudoternary sulfide, and pseudoquaternary sulfide.

11. A battery cell comprising:
a plurality of individual anode electrodes comprising an anode current collector; and
a continuous cathode electrode comprising a cathode current collector, cathode active material arranged on opposite sides of the cathode current collector at spaced intervals, and a first sulfide electrolyte layer arranged on the cathode active material and on the cathode current collector in between the cathode active material,
wherein the continuous cathode electrode is arranged in a zig-zag pattern and the plurality of individual anode electrodes are located between adjacent alternating portions of the continuous cathode electrode.

12. The battery cell of claim 11, wherein the plurality of individual anode electrodes further includes anode active material arranged on opposite sides of the anode current collector.

13. The battery cell of claim 12, wherein the anode active material includes a material selected from a group consisting of a carbonaceous material, silicon, a transition metal, a metal oxide, a lithium metal, a lithium alloy metal, and combinations thereof.

14. The battery cell of claim 13, wherein the lithium alloy metal further comprises a material selected from a group consisting of tin, aluminum, indium, and magnesium.

15. The battery cell of claim 11, wherein the cathode active material comprises one or more positive electroactive materials selected from a group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof.

16. The battery cell of claim 15, wherein the positive electroactive materials are coated.

17. The battery cell of claim 15, wherein the positive electroactive materials are coated with one or more materials selected from a group consisting of LiNbO₃ and Al₂O₃.

18. The battery cell of claim 15, wherein the positive electroactive materials are doped.

19. The battery cell of claim 15, wherein the positive electroactive materials are doped with one or more materials selected from a group consisting of aluminum and magnesium.

20. The battery cell of claim 11, wherein the first sulfide electrolyte layer is selected from a group consisting of pseudobinary sulfide, pseudoternary sulfide, and pseudoquaternary sulfide.
